(19) United States
(12) Patent Application Publication
(10) Pub. No.: US 2026/0000247 A1
(43) Pub. Date: Jan. 1, 2026

(54) STORAGE CONTAINERS WITH FLEXIBLE AND EXPANDABLE CLEAR TOPS

(71) Applicant: Home Worldwide LLC, New York, NY (US)

(72) Inventor: Isaac Safdieh, New York, NY (US)

(21) Appl. No.: 18/757,671

(22) Filed: Jun. 28, 2024

(51) Int. Cl. A47J 47/08; B65D 43/02

(52) U.S. Cl. CPC A47J 47/08; B65D 43/0212

(57) ABSTRACT

A food storage container having a main body and a lid with a locking mechanism. The main body has an internal volume sized to accommodate various food items. The locking mechanism of the lid selectively secures the lid to the main body. The lid includes a centrally located window portion incorporated into the lid. The window portion is made of a flexible, expandable and transparent material, allowing the window portion to stretch vertically to accommodate food items extending beyond the internal volume of the main body of the container. The window portion is also clear to allow for visual identification of the food items within the main body of the container.

### BACKGROUND

The present disclosure is generally directed to containers of the type used, for example, to store food in refrigerators, etc. More specifically, the present invention relates to storage containers equipped with flexible and expandable clear tops, offering versatility and ease of use.

Food containers are essential for storing and transporting food items conveniently and safely. In the present state of the art, as shown and described for example in U.S. Pat. No. 4,951,832, various food storage container systems are known. Each such system typically includes a plurality of containers with corresponding lids. The inner surface of each lid is typically contoured either to snap-fit over the open top or onto the bottom of its respective container. The different sized containers then can be stacked in a nested configuration, one inside the other. In this arrangement, however, all lids are made with solid non-expandable tops. As such, food items which exceed the inner volume of the container will either be squashed by the lid or will not be able to fit within the closed container altogether. This can lead to inconvenience and food waste. Therefore, there is a need for a food container with an expandable clear window top that allows users to accommodate food of various volumes and to easily view the contents inside.

### SUMMARY

In its general aspect, the present invention is a food container designed to address the aforementioned issues. The container features a main body and a clear expandable silicon window incorporated into the lid, allowing for easy identification of contents and adaptability to accommodate items of various shapes and sizes. The flexible and expandable nature of the clear window portion ensures a secure positioning of the food items within, while offering versatility in storage capacity. The clear nature of the top also provides users with a visual means to identify the contents without opening the container. This enhances convenience, reduces food waste, and improves overall user experience.

The containers utilizing the lids contracted in accordance with the proposed design offer an increased versatility and visibility and provide a secure positioning of the food inside. Specifically the flexible and expandable clear top allows the storage container to accommodate items of various shapes and sizes. The transparent nature of the clear top enables easy identification of contents without the need to open the container. Finally, the expandable clear top forms a tight seal around the top portions of the food items positioned inside the container, thus ensuring the contents remain secure during storage and transportation.

### BRIEF DESCRIPTION OF THE DRAWINGS

The invention is illustrated by way of examples which are not a limitation, and the figures of the accompanying drawings in which references denote corresponding parts, and in which:

FIG. 1 shows a view of storage containers in accordance with a first embodiment of the present invention;

FIG. 2 shows a view of storage containers in accordance with a second embodiment of the present invention;

FIG. 3 shows a view of storage containers in accordance with a third embodiment of the present invention; and

FIG. 4 shows a top view of one preferred embodiment of a container's lid.

### DETAILED DESCRIPTION

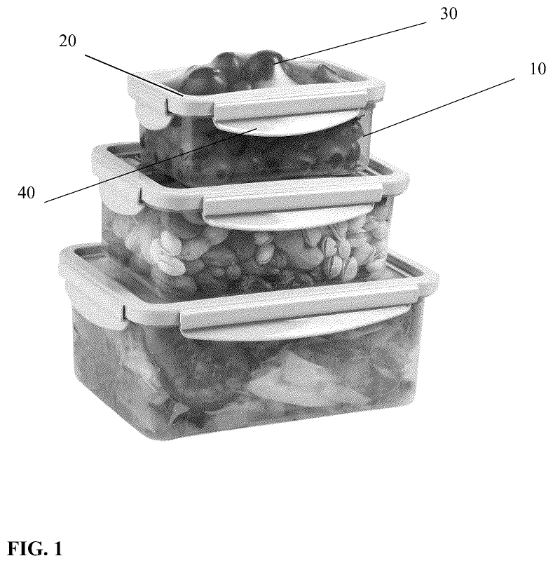

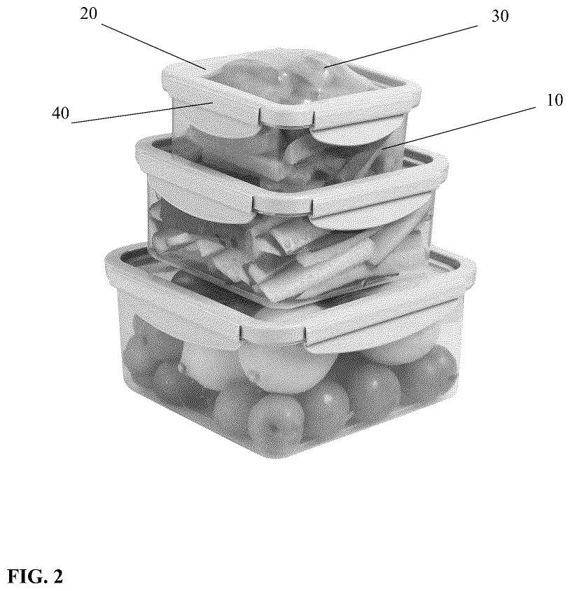

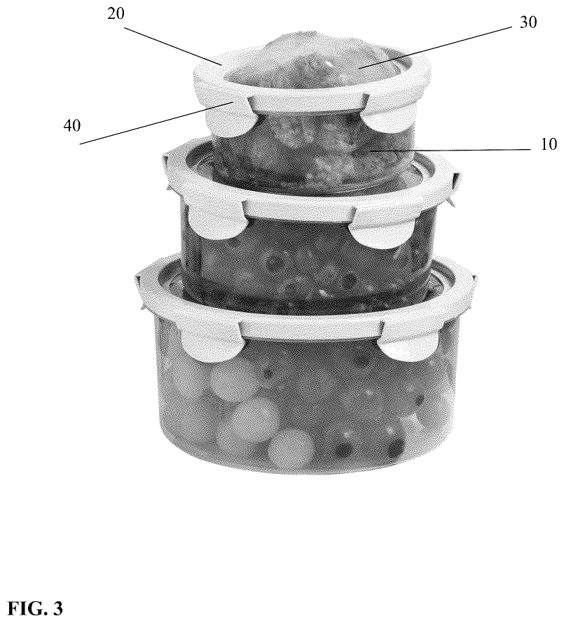

As shown in FIGS. 1-3, the food container comprises a main body 10 and a lid 20. The main body 10 has an internal volume sized to accommodate various food items. The main body 10 is typically made of a durable material such as plastic, glass, or stainless steel, capable of securely holding these food items. The lid 20 is also made of a similar durable material and features a clear window portion 30 positioned centrally. The lid can be selectively secured to the main body using locking mechanisms 40. Each locking mechanism preferably includes snap-lock tabs 42 or other suitable fasteners to prevent accidental opening during storage or transportation.

The clear window portion 30 is made of a flexible and transparent material, preferably silicone. Because the window portion is transparent, it allows users to view the contents of the container without needing to open the lid. The silicon material offers flexibility, durability, and a tight seal, ensuring that the contents remain fresh and secure during storage and transportation. As shown in FIGS. 1-4, the clear window portion is designed to be expandable, allowing it to stretch vertically to accommodate items of varying heights. This expandability is achieved through selecting a particular thickness of the silicon material. The preferred thickness of the silicon material is in the range of 0.4 mm to 0.8 mm, most preferably-0.6 mm.

The silicon window portion is tightly sealed within the lid, ensuring that the container remains leak-proof and airtight, preserving the freshness of the food items.

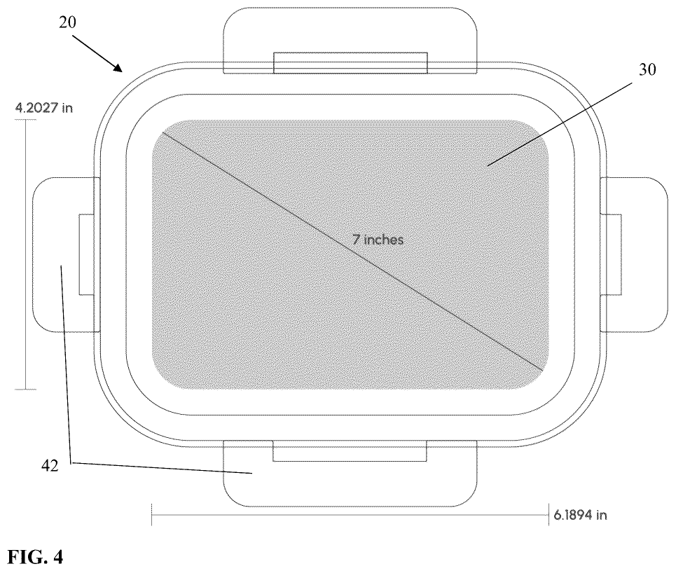

In one embodiment, the clear silicon window portion is integrated into the lid during the manufacturing process, ensuring a seamless and leak-proof design. As shown in FIGS. 1-3, the window portions of the lids, may have various shapes and sizes, depending on the overall design of the container. The preferred embodiment of a rectangular lid with a rectangular clear silicon window portion is shown in FIG. 4. In this embodiment, the clear window portion has a 7″ diagonal dimension, and is approximately 4.2″ by 6.2″.

In use, a consumer will position the desired food items into the main body 10 and secure the lid 20 to the main body using the locking mechanism 40. If the food items extend beyond the volume of the closed container, the window portion 30 will expand vertically to accommodate the additional volume, as needed, and to stretch around the top portion of the food items to securely hold them in place within the container.

The food container with a clear expandable silicon window portion within the lid is a novel invention that enhances convenience, reduces food waste, and improves overall user experience. Its innovative design offers a practical solution to the limitations of conventional food containers, making it a valuable addition to the food storage industry.

In the preceding specification, the invention has been described with reference to specific exemplary embodiments thereof. It will however, be evident that various modifications and changes may be made thereto without departing from the broader spirit and scope of the invention as set forth in the claims that follow. The specification and drawings are accordingly to be regarded in an illustrative manner rather than a restrictive sense.

We claim as follows:

1. A food storage container comprising:
a main body having an internal volume sized to accommodate various food items; and
a lid having a locking mechanism, the locking mechanism selectively securing the lid to the main body, the lid further comprising a centrally located window portion incorporated into the lid, wherein said window portion comprises a flexible, expandable and transparent material, wherein said window portion is stretchable vertically to accommodate food items extending beyond the internal volume of said main body, and wherein said window portion is clear to allow for visual identification of said food items within said main body.

2. The food storage container in accordance with claim 1, wherein said flexible, expandable and transparent material is silicon having a thickness of 0.4 mm to 0.8 mm.

3. The food storage container in accordance with claim 2, wherein said flexible, expandable and transparent material is silicon having a thickness of 0.6 mm.

4. The food storage container in accordance with claim 1, wherein said window portion is rectangular in shape.

5. The food storage container in accordance with claim 1, wherein said window portion is square in shape.

6. The food storage container in accordance with claim 1, wherein said window portion is round in shape.
